(19) United States
(12) Patent Application Publication
(10) Pub. No.: US 2023/0240923 A1
(43) Pub. Date: Aug. 3, 2023

(54) SMART MEDBED

(71) Applicant: Baylor College of Medicine, Houston, TX (US)

(72) Inventor: Sharmila Anandasabapathy, Houston, TX (US)

(73) Assignee: Baylor College of Medicine, Houston, TX (US)

(21) Appl. No.: 18/001,491

(22) PCT Filed: Aug. 30, 2021
(86) PCT No.: PCT/US2021/071307

§ 371 Date: Dec. 12, 2022

Related U.S. Application Data
(60) Provisional application No. 63/072,425, filed on Aug. 31, 2020.

(51) Int. Cl. A61G 7/05

(52) U.S. Cl. CPC A61G 7/0506

(57) ABSTRACT

One aspect of the invention provides a self-contained patient-bed-and-headboard assembly including: a patient bed and a headboard. The patient bed includes: a central region; a head region hingedly attached to the central region; and a foot region hingedly attached to the foot region. Both the head region and the foot region can rotate between: a first position in which the head region and the foot region are substantially upright; and a second position in which the head region and the foot region are coplanar. Both the head region and the foot region each comprise one or more lateral attachment points. The headboard includes one or more complementary attachments points adapted and configured to engage with the one or more lateral attachment points of the head region and the foot region of the patient bed when in the first position.

### CROSS-REFERENCE TO RELATED APPLICATION(S)

This application claims the benefit of priority of U.S. Provisional Patent Application Ser. No. 63/072,425, filed Aug. 31, 2020. The entire content of this application is hereby incorporated by reference herein.

### BACKGROUND OF THE INVENTION

Current and recent outbreaks underscore the need for a more ‘nimble’ response that addresses a multitude of issues from transportation, access, facilities, equipment, and communication to provider training.

### SUMMARY OF THE INVENTION

One aspect of the invention provides a self-contained patient-bed-and-headboard assembly including: a patient bed and a headboard. The patient bed includes: a central region; a head region hingedly attached to the central region; and a foot region hingedly attached to the foot region. Both the head region and the foot region can rotate between: a first position in which the head region and the foot region are substantially upright; and a second position in which the head region and the foot region are coplanar. Both the head region and the foot region each comprise one or more lateral attachment points. The headboard includes one or more complementary attachments points adapted and configured to engage with the one or more lateral attachment points of the head region and the foot region of the patient bed when in the first position.

This aspect of the invention can have a variety of embodiments. The lateral attachment points can be rails. The lateral attachment points can have a keyed profile. The complementary attachment points can be grooves.

The headboard can include: a front portion; and a rear portion adapted and configured to couple to the front portion to form an A-frame. Each of the front portion and the rear portion can include the one or more complementary attachment points. The front portion of the headboard and the rear portion of the headboard can each be adapted and configured to couple to a separate lateral side of the patient bed.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts an exemplary Smart Medbed as contemplated herein. The Smart Medbed includes a portable, foldable bed designed for patient care in situations requiring rapid set up and response, such as natural disasters or outbreaks. The bed is designed to be cleaned and disinfected easily and to be used with a requisite clinical features such as intravenous tubing and poles, monitors and other patient care technologies.

FIG. 2 depicts an exemplary Smart Medbed of the present invention including an exemplary easeled headboard and exemplary bed in a fully opened position so that a patient can lay flat on the bed. A patient can be secured to the bed by one or more belts that help prevent a patient from rolling out of bed.

FIG. 3 depicts an exemplary Smart Medbed as viewed from behind the head of the bed. In this particular embodiment, the central segment does not include a central opening.

FIG. 4 depicts an exemplary Smart Medbed as contemplated herein, where the central segment of the pad includes a central opening. The central opening may be used for allowing access to objects under the bed and/or for facilitating the use of a bedpan and other such items for patients in need of the use thereof.

FIG. 5 depicts an exemplary support for the head of the bed allowing a patient to elevate his or her upper body.

FIG. 6 depicts an exemplary headboard. The headboard may include a ledge for holding equipment such as monitoring devices, and has rungs or brackets for attaching accessories such as brackets for fluid or gas lines, and the like.

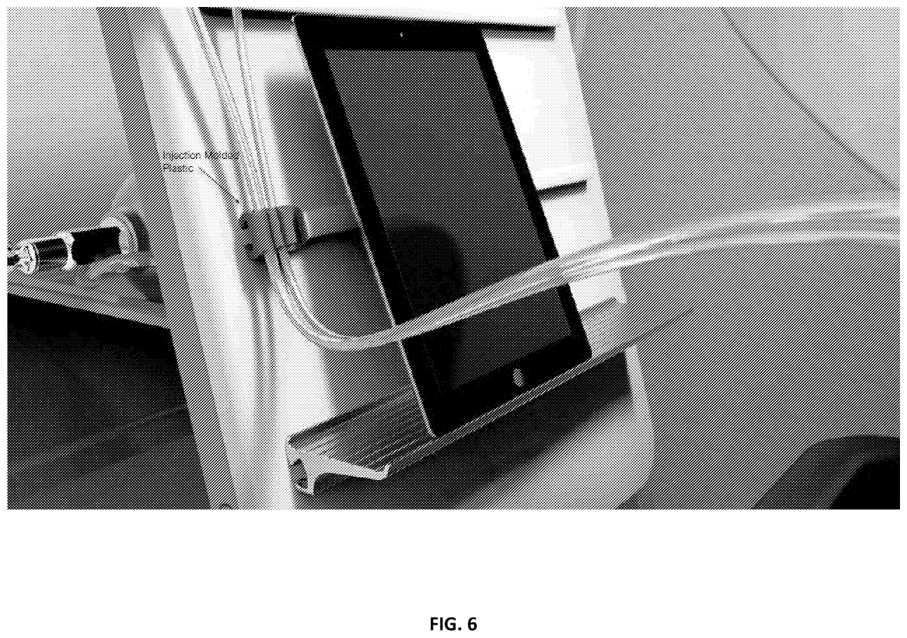

FIG. 7 depicts a top projection of an exemplary easeled headboard of the present invention. The headboard can include oxygen supply equipment including flow meters, mixing chambers and the like. The assembled, easeled headboard can also include a shelf for storing, for example oxygen or blood gas bottles that engage with equipment attached to and engaging with the assembled headboard.

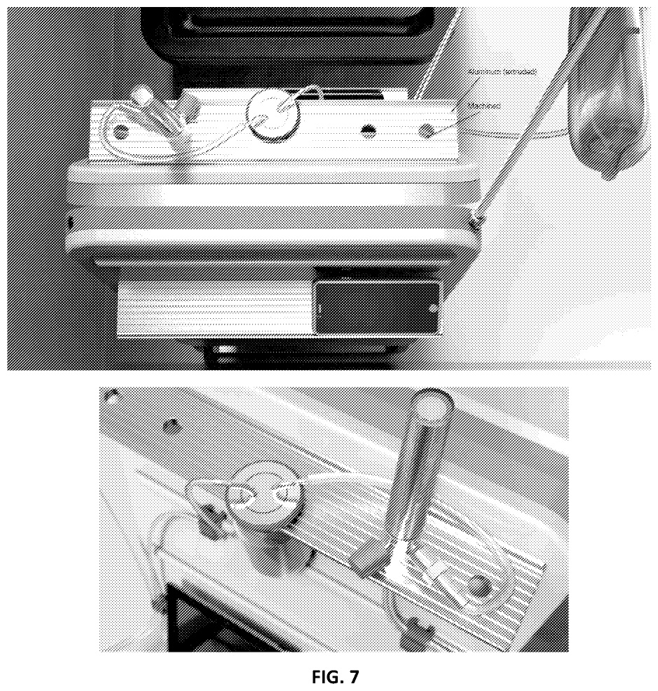

FIG. 8 depicts as assembly drawing of the bed including the pad, the frame, and the pad and frame assembled together.

FIG. 9 depicts an exemplary drawing of the bed frame highlighting the structural elements of the frame. The frame is positioned so that the head of the bed is elevated.

FIG. 10 depicts an exemplary Smart Medbed folded up in a configuration for storage and/or transport.

FIG. 11 depicts a four-view orthogonal schematic of the bed in the folded configuration.

FIG. 12 depicts an exemplary detachment point of a detachable support of the bed.

FIG. 13 highlights the keyed groove in a headboard panel engaging with an attachment point in the frame of the bed.

FIG. 14 depicts the handles on the top of the head of the frame and on the bottom of the foot of the frame engaging and being secured with a strap on an exemplary Medbed in a closed configuration for storing.

FIG. 15 depicts the disassembled parts of the Medbed and headboard highlighting that the panels detached from the frame of both the bed and headboard.

FIG. 16 depicts a cross-sectional view of the Medbed in a closed configuration for storing. From the cross-sectional view, the folded headboard frame can be seen contained within a compartment formed on the interior of the folded bed.

FIG. 17 a four-view orthogonal schematic of the easeled headboard in an assembled configuration.

FIG. 18 depicts a bottom projection of the easeled headboard. The supports of the headboard component snap into slots in the bottom of the headboard frame

FIG. 19 depict a telescoping i.v. stand arm extending from the frame of the headboard.

FIG. 20 depicts gas lines extending along the side edge the bed and headboard. The right panel depicts brackets for securing the tubing which are secured to the attachment points along the side edge of the bed frame.

FIG. 21 depicts the Medbed with an exemplary single-panel headboard that may be secured to a wall bracket when in use. This design for the headboard allows for a more compact design.

FIG. 22 depicts an exemplary adjustable lamp that can be attached to the headboard for use as needed during administration of patient care.

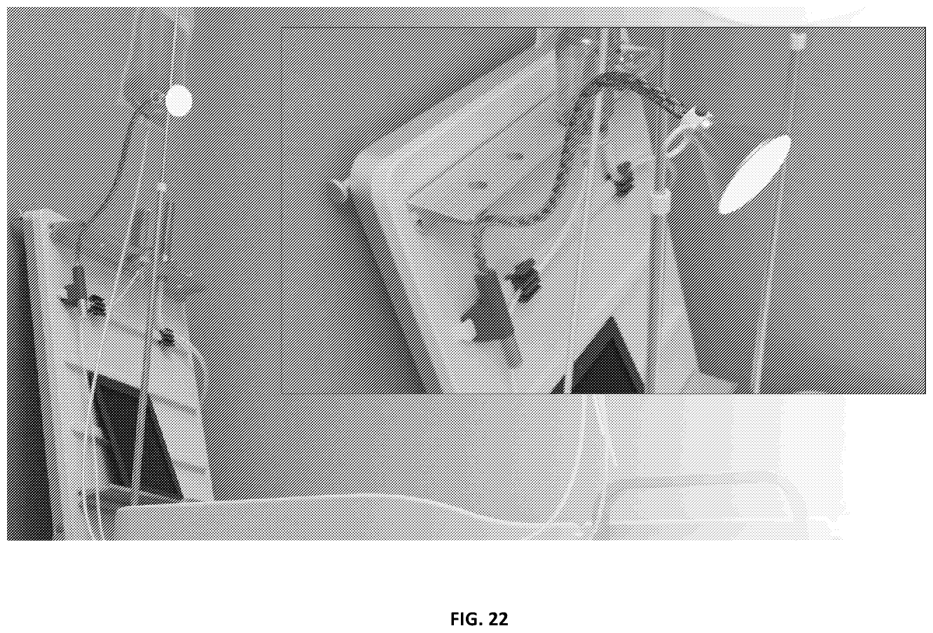

FIG. 23 depicts an exemplary canister lamp that can be attached to the i.v. stand for use as needed during administration of patient care.

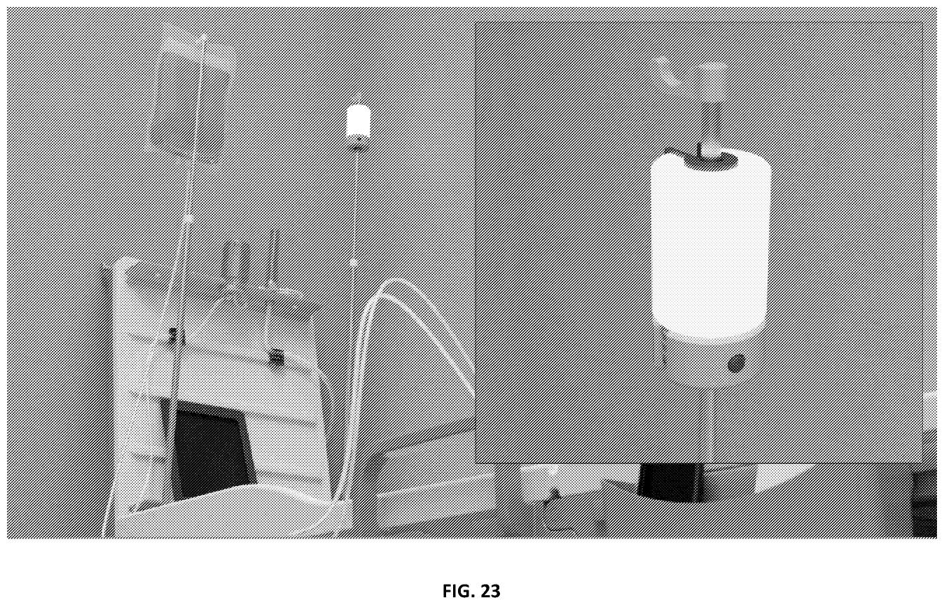

FIG. 24 depicts an exemplary lantern that can be hung from the i.v. stand for used as needed during administration of patient care.

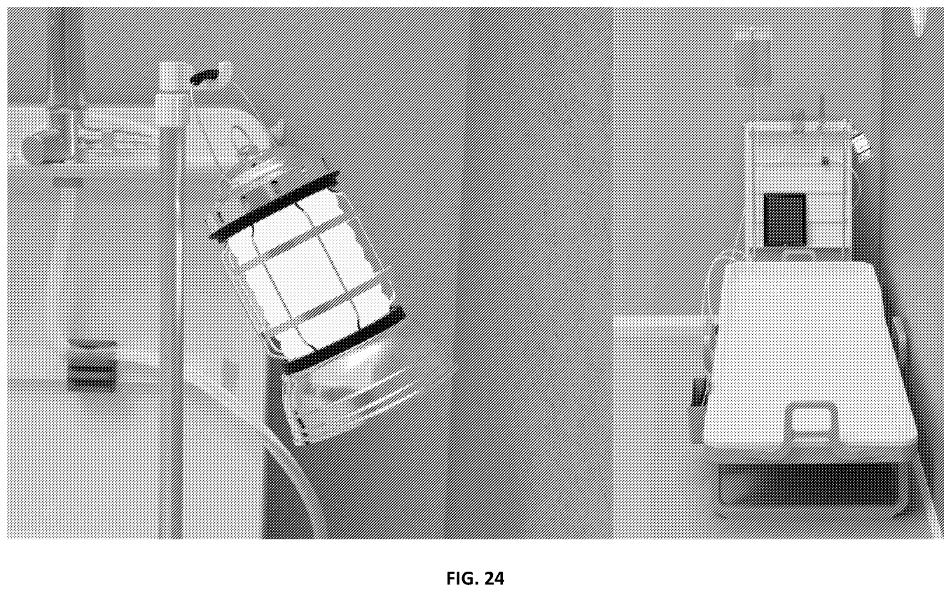

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about. As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

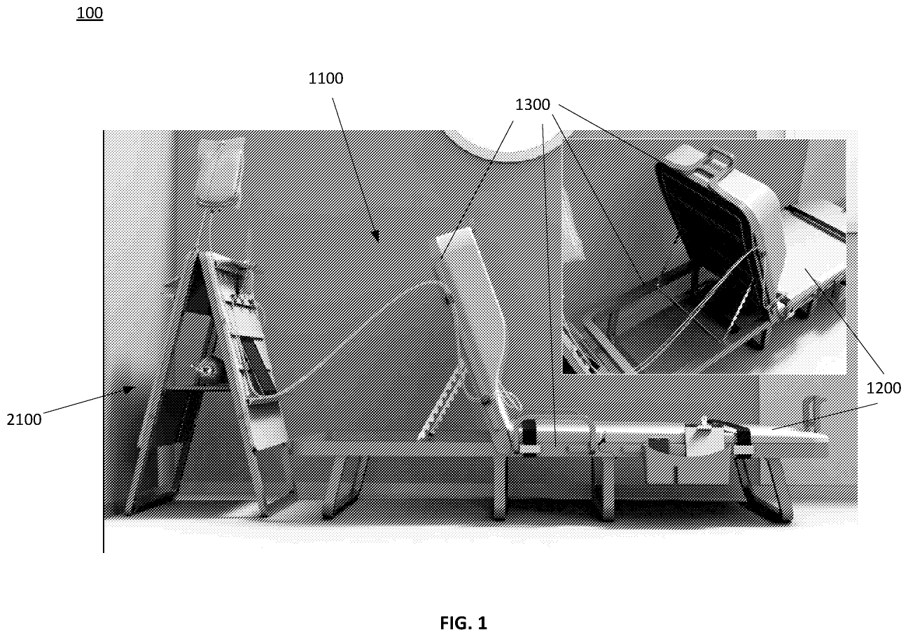

The present invention provides a self-contained, portable medical patient bed-and-headboard assembly, shown in FIG. 1, and methods for use thereof. Embodiments of the bead and headboard assembly include a portable medical patient bed, and a headboard. The patient bed is collapsible and includes a frame and a pad. The headboard frame can be collapsible and include a front panel attached to a rear panel by one or more hinges along a seam. In a collapsed configuration, the collapsed headboard can interlock with the collapsed patient bed. In an assembled configuration, the headboard can be positioned adjacent to the patient bed and may be attached to or positioned independent from the patient bed.

Patient Bed Component

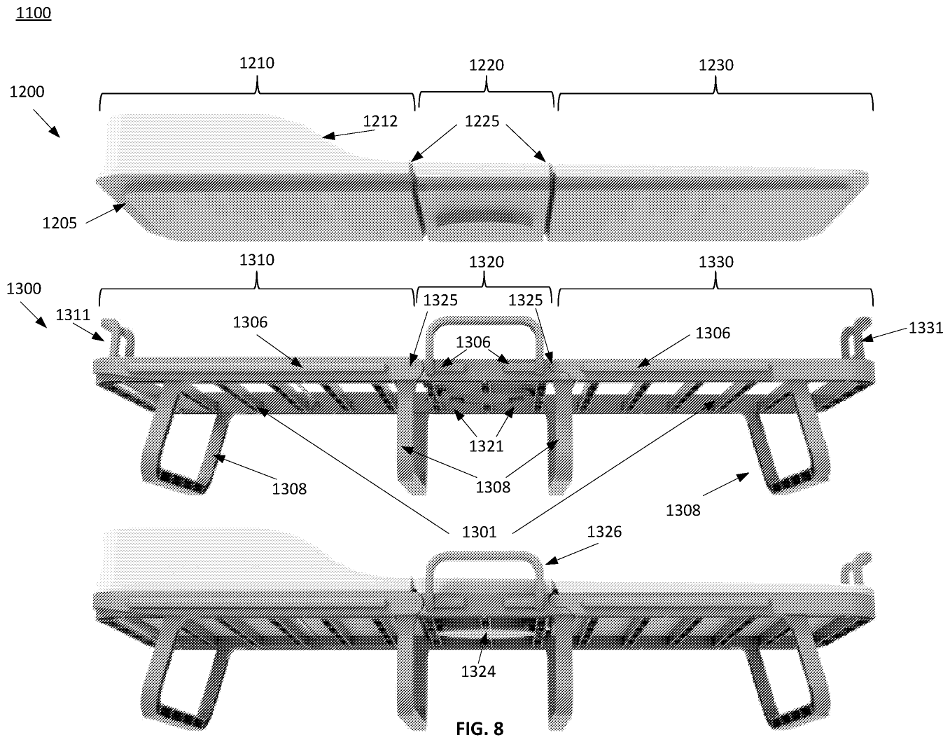

Referring now to FIG. 8, the patient bed component 1100 of patient bed-and-headboard system 100 can include a pad 1200 and a frame 1300. Pad 1200 of patient bed 1100 can have three segments including a head segment 1210, a central segment 1220, and a foot segment 1230. Frame 1300 can also have three segments including a head segment 1310, a central segment 1320, and a foot segment 1330. Each of the three segments of pad 1200 can removably overlay the corresponding segment of the underlying frame 1300, as shown in the bottom panel of FIG. 8. The pad 1200 may be connected to the frame 1300 by one or more fasteners including for example, one or more snaps, buttons, straps, hook-and-grooves, snap hooks, loop-and hooks, screws, bolts, nails, rivets, and the like, and/or combinations thereof.

Pad

Referring now to FIG. 8, the pad portion of the patient bed according to the present invention can include a head segment 1210, a central segment 1220, and a foot segment 1230. Pad 1200 can be secured on top of frame 1300. Embodiments of pad 1200 include one or more ridges or rabbets 1205 on the bottom side of the pad, as shown in the top image in FIG. 8. The one or more ridges or rabbets 1205 can interlock pad 1200 with frame 1300 for securing pad 1200 to the frame 1300.

Head segment 1210 of pad 1200 can be a planar pad configured for supporting the upper body including the torso and head of a patient. Head segment can have a length and width sufficiently long and wide to support an average human adult. For example, head segment 1210 may have a length ranging from about 0.1 m to about 0.2 m, from about 0.2 m to about 0.3 m, from about 0.3 m to about 0.4 m, from about 0.4 m to about 0.5 m, from about 0.5 m to about 0.6 m, from about 0.6 m to about 0.7 m, from about 0.7 m to about 0.8 m, from about 0.8 m to about 0.9 m, from about 0.9 m to about 1.0 m, and any and all increments therebetween. Head segment 1210 may have a width of up to about 0.3 m, from about 0.3 m to about 0.35 m, from about 0.35 m to about 0.4 m, from 0.4 m to about 0.45 m, from about 0.45 m to about 0.5 m, from about 0.5 m to about 0.55 m, from about 0.55 m to about 0.6 m, from about 0.6 m to about 0.65 m, from about 0.65 m to about 0.7 m, and any and all increments therebetween.

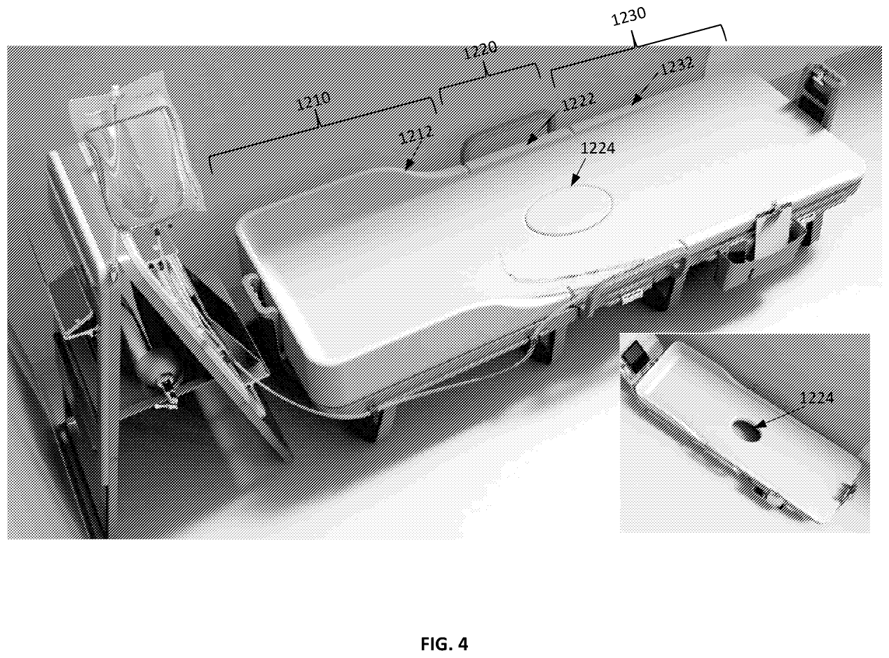

Referring now to FIG. 4, embodiments of head segment 1210 may include a flange 1212 extending around the perimeter of head segment 1210. The flange 1212 may extend a height from pad portion 1200 in order to prevent a patient from rolling off of patient bed 1100. For example, flange 1212 may extend a height including up to about 0.1 cm to about 0.5 cm, from about 0.5 cm to about 1 cm, from about 1 cm to about 5 cm from about 5 cm to about 10 cm, from about 10 cm to about 15 cm, from about 15 cm , about 20 cm, from about 20 cm to about 25 cm, from about 25 cm to about 30 cm, and so on, including any and all increments therebetween.

Central segment 1220 of pad 1200, shown in FIG. 8, can be connected to head segment 1210 and foot segment 1230 along hinge regions 1225. Central segment 1220 can extend contiguously from head segment 1210. Central segment 1220 can have the same width as head region 1210. Embodiments of central segment 1220 can include a flange 1222 extending from the outer edges. The flange may have a constant height. The height of the flange along the edges of central region may have a height that matches the lowest height of flange 1222 extending from the edges of head region 1210. For example, the central segment flange may have a maximum height of up to about 0.1 cm, from about 0.1 cm to about 0.5 cm, from about 0.5 cm to about 1.0 cm, from about 1.0 cm to about 1.5 cm, from about 1.5 cm to about 2.0 cm, from about 2.0 cm to about 2.5 cm, from about 2.5 cm to about 3.0 cm, from about 3.0 cm to about 3.5 cm, from about 3.5 cm to about 4.0 cm, from about 4.0 cm to about 4.5 cm, from about 4.5 cm to about 5.0 cm, and so on, including any and all increments therebetween. Central segment 1220 may have a length of up to about 10 cm, from about 10 cm to about 15 cm, from about 15 cm to about 20 cm, from about 20 cm to about 25 cm, from about 25 cm to about 30 cm, from about 30 cm to about 35 cm, from about 35 cm to about 40 cm, from about 40 cm to about 45 cm, from about 45 cm to about 50 cm, including any and all increments therebetween. Referring now to FIG. 4, embodiments of central segment can include a removable and resealable central opening 1224. The central opening 1224 may be configured or adapted for allowing for defecation and/or urination when a patient is confined to the bed. The central opening 1224 may be adapted and configured for interfacing with a specimen collection device such as a bed pan. The central opening 1224 may have any suitable shape including a curved shape, such as a circle or oval. The opening 1224 may have a maximum width of up to about 5 cm, from about 5 cm to about 10 cm, from about 10 cm to about 15 cm, from about 15 cm to about 20 cm, from about 20 cm to about 25 cm, from about 25 cm to about 30 cm, from about 30 cm to about 35 cm, from about 35 cm to about 40 cm, and so on, including any and all increments therebetween.

Foot segment 1230 of pad 1200, shown in FIG. 8 is connected to central segment 1220 along hinge region 1225. Foot segment 1230 extends contiguously from central segment 1220. Foot segment 1230 has the same width as head segment 1210 and central segment 1220. Embodiments of foot segment 1230 can include a flange 1232, shown in FIG. 4, extending along the side edges. Embodiments of the flange 1232 along the side edges of foot segment 1230 have a constant height matching that of the flange along the outer edges of central segment 1220. Embodiments of the flange 1232 along the side edges of foot segment 1230 have a tapering height starting with a maximum height matching that of the flange 1222 along the outer edges of central segment 1220 and tapering to being coplanar with the top surface of the pad. Pad 1200 may be constructed from any suitable sterilizable material as understood in the art. For example, pad 1200 may be constructed from one or more polymers including one or more thermopolymers such as polyvinyl chloride, polypropylene, acrylonitile butadiene styrene (ABS), polycarbonate (PC), glycol-modified polyethylene teraphylate (PETG), polylypropylene (PP) and polymethyl methacrylate (PMMA), and the like. In some embodiments, the pad is treated with one or more antimicrobial remediating agents, either prepared with the polymer material, as a surface treatment, and/or one or more combinations thereof. The antimicrobial coating may include one or more of zinc and copper alginate fibers; nanoparticles such as silver nanoparticles; antibiotics, iodine, chloride, etc.; or light-activated molecules as titanium dioxide or photosensitizers, and/or one or more combinations thereof. In some embodiments, the pad may be constructed from one or more antimicrobial fabrics that may contain one or more polymers including, for example polyester, polyester-vinyl composites, vinyl, or other fabrics as understood in the art that include antimicrobial properties.

Frame

Referring now to FIG. 8, the frame 1300 of patient bed 1100 can include a head segment 1310, a central segment 1320 and a foot segment 1330. Frame 1300 supports pad 1200 and removably interlocks with pad 1200, as described elsewhere herein. Frame 1300 can have a first handle 1311 extending from the top of head segment 1310 and a second handle 1331 extending from bottom of foot segment 1330.

Frame 1300 can include a plurality of crossbars 1301 oriented parallel to the short sides of the frame and extend the length of frame 1300. Crossbars 1301 provide structural support to frame 1300 and support the weight of pad 1200 and any additional loads placed on top of pad 1200, including, for example, patients. Crossbars 1301 may be spaced a distance of up to about 4 cm, from about 4 cm to about 8 cm, from about 8 cm to about 12 cm from about 12 cm to about 16 cm, from about 16 cm to about 20 cm, and so on.

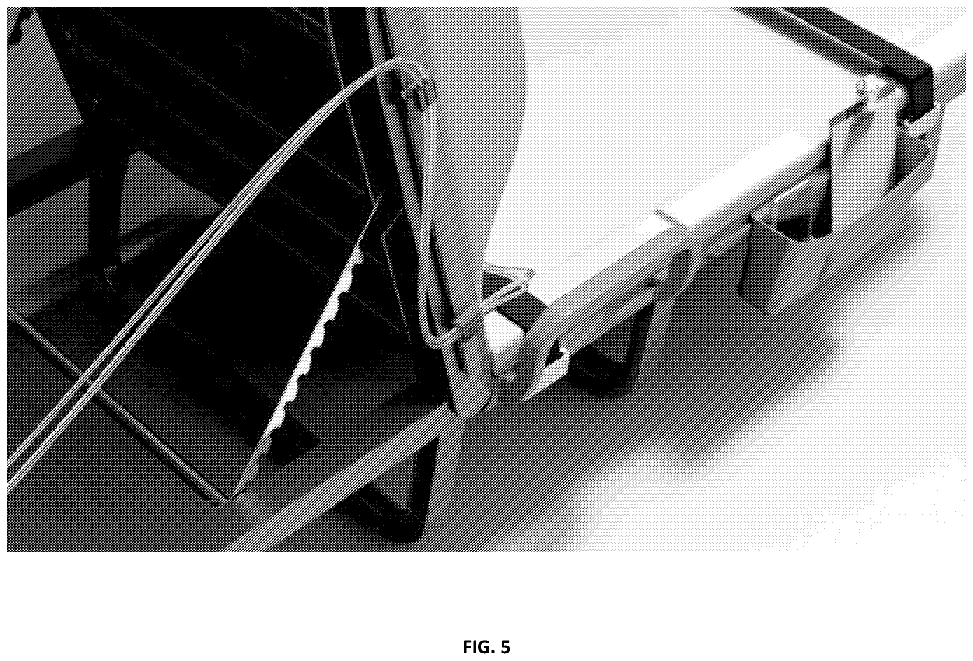

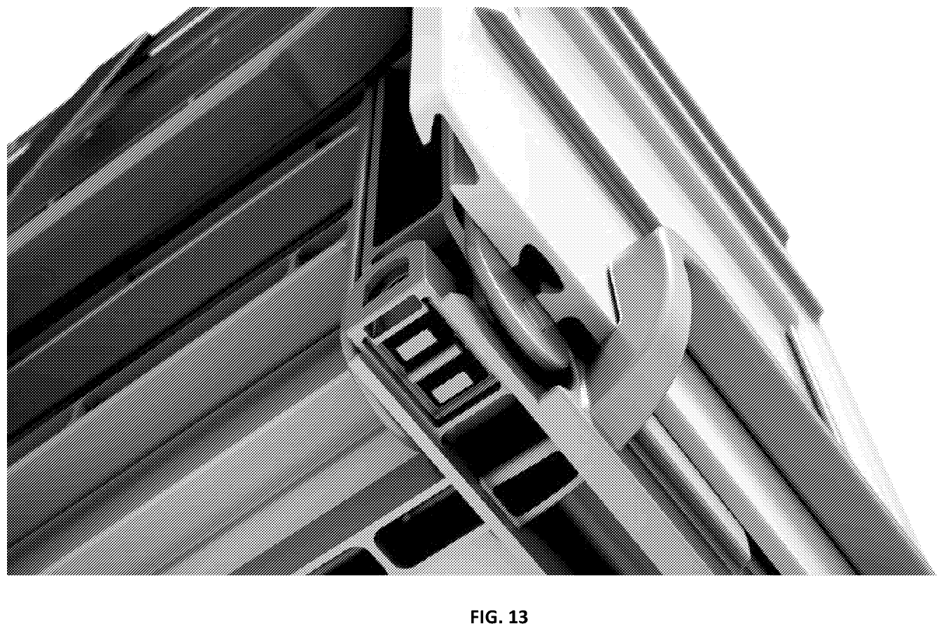

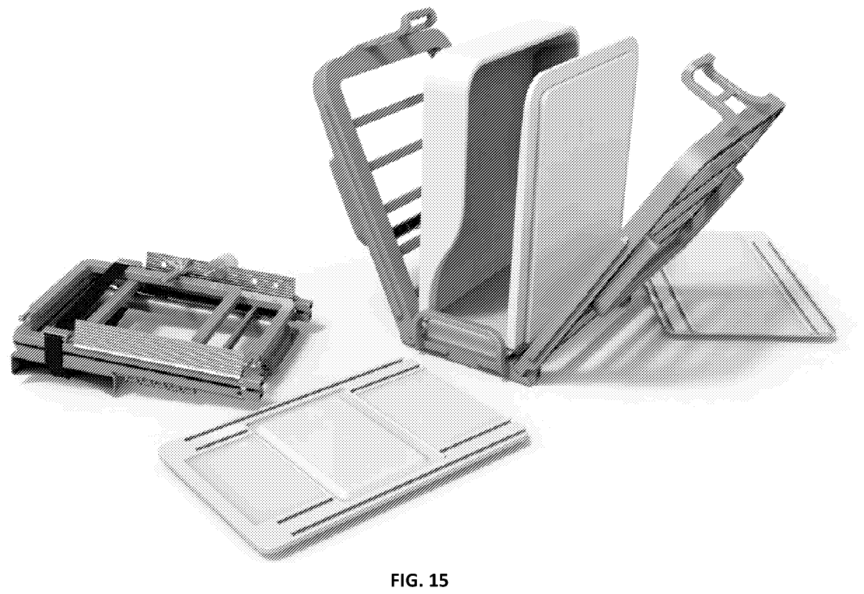

A plurality of keyed brackets 1306 can extend outwardly from the sides of frame 1300. The brackets 1306 provide an attachment point for attaching accessories to the sides of patient bed 1100 when assembled for patient use. As shown in FIG. 8, the brackets 1306 may be positioned on the outer edge the frame head segment 1310, central segment 1320, and/or foot segment 1330. One or more brackets 1306 may be positioned on each segment and may be used for attaching accessories to patient bed 1100 when in use. For example, as illustrated in FIG. 5, one or more trays can be hung from the keyed bracket. In addition, one or more clips for securing fluid lines, equipment power lines, and the like can be attached to bracket 1306. As shown in FIG. 5, clips can be oriented parallel to bracket 1306, perpendicular to bracket 1306, or any orientation therebetween. In addition to trays and clips, brackets 1306 can engage with other accessories for aiding in organization and/or implementation of patient care. For example, one or more accessories such as one or more of: IV poles, IV tubing, cords from monitoring devices such as blood pressure cuffs, pulse oximeters, and the like, may be included. In addition, as shown in FIGS. 13 and 15, the one or more keyed brackets 1306 can also be used for bundling the patient bed-and-headboard assembly for packing, transporting, and/or storing the assembly, discussed in greater detail below.

Referring now to FIG. 8, a plurality of supports 1308 can extend from the bottom of frame 1300 forming feet for elevating the patient bed above the ground when in use. The supports 1308 extend from the bottom of patient bed 1100 for elevating the bed above the ground when in use. Embodiments of the supports 1308 include u-shaped reinforced bars that extend from frame 1300 that extend the width of or significant portion thereof the patient bed.

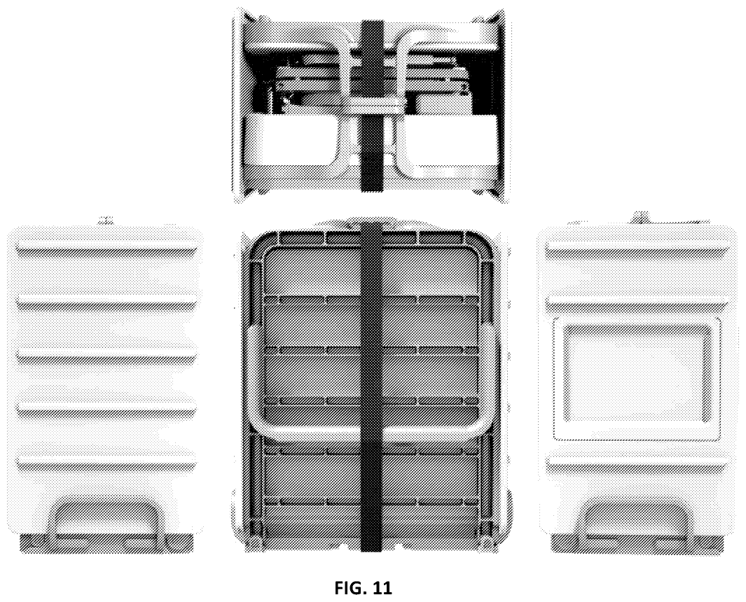

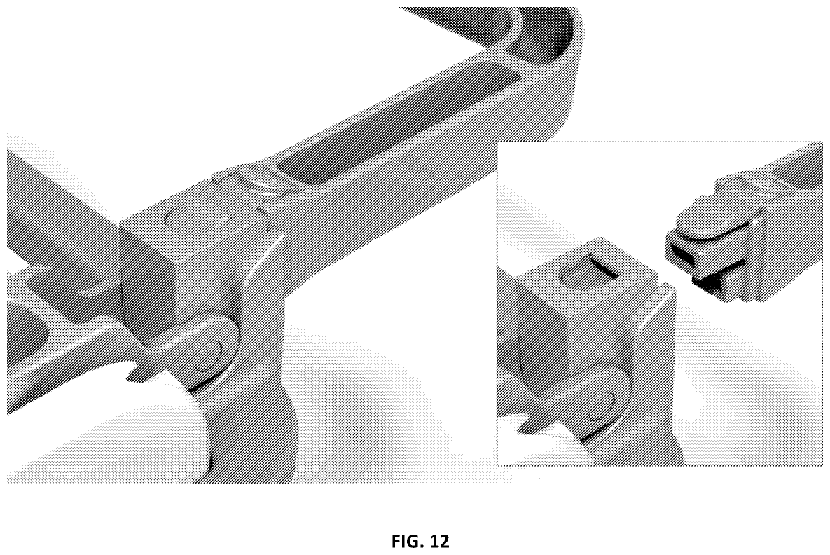

Embodiments of the supports 1308 fold out in an active configuration and fold in-line with the frame in a resting configuration, demonstrated in FIG. 11. For example, the supports 1308 positioned on the frame's head segment 1310 and foot segment 1330 can be hinged and fold away from the frame into an active assembled configuration such as that depicted in FIGS. 4 and 8. Embodiments of the supports 1308 are fixed in position extending from the bottom of the frame and are detachable. For example, as shown in FIG. 12, supports 1308 positioned on the bottom of central segment 1320 of frame 1300 lock into place for use and detach from frame 1300 or storage and transport of the patient bed assembly. Embodiments of supports 1308 include removable casters for rolling the assembled patient bed around on a floor surface. Embodiments of supports include friction pads for preventing sliding around on a floor surface. Supports 1308 elevate patient bed 1100 above the ground or floor a height that allows an average-height patient to easily sit or lay on patient bed 1100 without assistance and allows one or more medical practitioner to easily interact with a patient on the bed. For example, supports 1308 may have a height of up to about 10 cm, from about 10 cm to about 20 cm, from about 20 cm to about 30 cm, from about 30 cm to about 40 cm, from about 40 cm to about 50 cm, from about 50 cm to about 60 cm, from about 60 cm to about 70 cm, from about 70 cm to about 80 cm, from about 80 cm to about 90 cm, from about 90 cm to about 100 cm, and any and all increments therebetween.

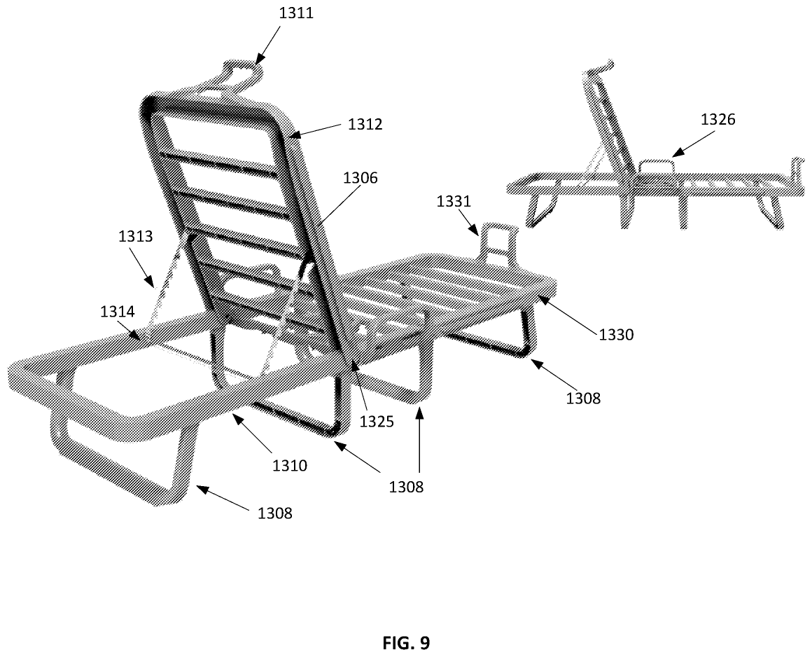

Referring now to FIG. 9, the head region 1310 of frame 1300 can hinge from central segment 1320 at hinge region 1325 and extend a length suitable to support the pad head segment 1210. Frame head segment 1310 can include a movable headrest 1312 for elevating the position of a patient's head and/or upper body while he or she is positioned on patient bed 1100. The headrest 1312 can overlay the tubular frame of head segment 1310 forming a shell fitting over the frame and hinges from the frame head segment 1310 also at hinge region 1325. Headrest 1312 can rotate from hinge region 1325 and form an angle with the non-rotating frame of head segment 1310. Headrest may rotate forming an angle of between about 0° and about 5°, between about 5° and about 10°, between about 10° and about 20°, between about 20° and about 30°, between about 30° and about 40°, between about 40° and about 50°, between about 50° and about 60°, between about 60° and about 70°, between about 70° and about 80°, between about 80° and about 90°, or about 90°.

Referring to FIG. 9, embodiments of headrest 1312 can be secured at a particular angle with, for example, a stand 1313 that rotates down from headrest 1312 and engages with stays 1314 on frame head segment 1310 to secure headrest 1312 into a particular position. The stand 1313 may lock into a particular position using a pin and ratchet, a hydraulic cylinder, or other suitable support mechanism as understood in the art. Headrest 1312 may be placed in a first or resting position wherein head region 1310 is coplanar with central region 1320. Headrest 1312 may be adjusted in order to allow a patient to assume a supine position, a Fowler's position, a semi-Fowler' s position, or any other suitable position as preferred by a medical practitioner.

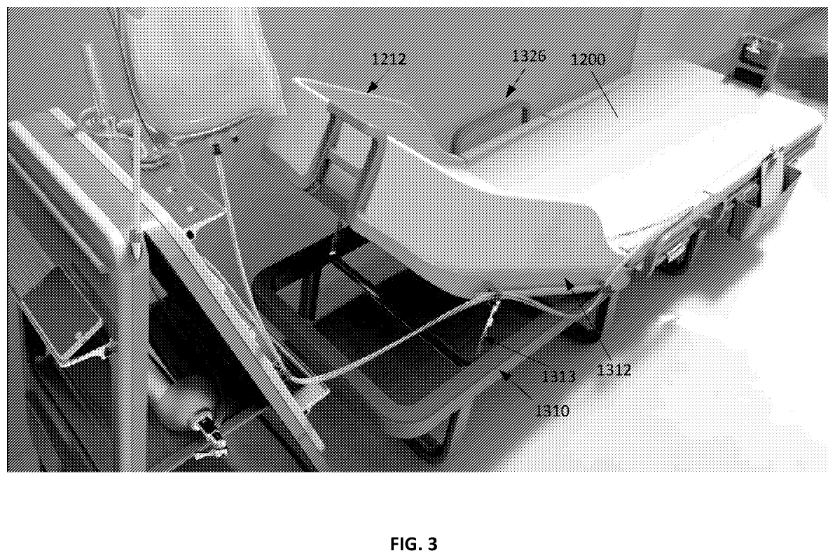

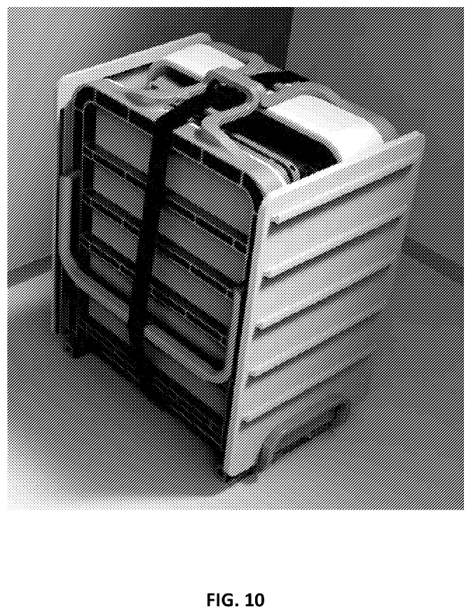

Referring to FIGS. 8 and 9, headrest 1312 can include a plurality of brackets 1306 on the outer surface of the sides of the head segment, as described elsewhere herein. Headrest 1312 can include a handle 1311 extending orthogonal to the plane of the frame. Handle 1311 can be centrally positioned along the top edge of head segment 1310. As shown in FIG. 3, handle 1311 can form a stop for securing the top of pad head segment 1210. As shown in FIG. 10, handle 1311 can align with a handle 1331 on the bottom portion of foot segment 1330 for securing patient bed 1100 in a folded configuration.

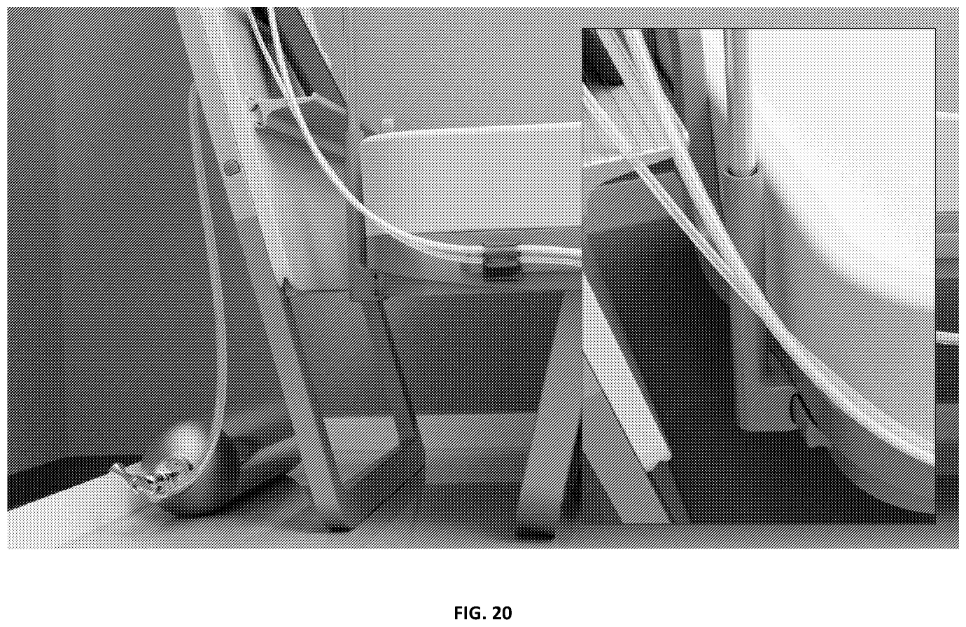

Head segment 1310 can be elevated above the ground by one or more folding head segment supports 1308. As shown in FIGS. 8 and 9, the support 1308 can hinge from head segment 1310 in an active configuration and, as shown in FIG. 20, fold flat along the bottom of frame 1300 in a resting position for storage and transport.

Frame head segment 1310 can have a length and width that complements the length and width of pad head segment 1210. Embodiments of frame head segment 1310 can extend a margin beyond the length and width of pad head segment 1310. For example, head segment may have a margin of up to about 1 cm, from about 1 cm to about 2 cm, from about 2 cm to about 3 cm, from about 3 cm to about 4 cm, from about 4 cm to about 5 cm, from about 5 cm to about 6 cm, and so on. Frame head segment 1310 may have a width of up to about 0.1 m to about 0.2 m, from about 0.2 m to about 0.3 m, from about 0.3 m to about 0.4 m, from about 0.4 m to about 0.5 m, from about 0.5 m to about 0.6 m, from about 0.6 m to about 0.7 m, from about 0.7 m to about 0.8 m, from about 0.8 m to about 0.9 m, from about 0.9 m to about 1.0 m, from about 1.0 m to about 1.5 m, and any and all increments therebetween. Frame head segment 1310 may have a width of up to about 0.3 m, from about 0.3 m to about 0.35 m, from about 0.35 m to about 0.4 m, from 0.4 m to about 0.45 m, from about 0.45 m to about 0.5 m, from about 0.5 m to about 0.55 m, from about 0.55 m to about 0.6 m, from about 0.6 m to about 0.65 m, from about 0.65 m to about 0.7 m, from about 0.7 m to about 0.75 m, and any and all increments therebetween.

Referring now to FIG. 8, in some embodiments, frame 1300 may include a central segment 1320 that supports the pad central segment 1220. Frame central segment 1320 can include a plurality of panels 1321. Embodiments of panels 1321 can have a configuration that complements the central opening 1224 of pad 1200. That is, the plurality of panels 1321 may include quadrants that align to form a central opening 1324. Panels 1321 may include one or more securing elements for attaching a specimen collection container such as a bed pan. For example, panels 1321 may include clips, straps, threading, cords, latches, and the like for securing one or more specimen collection containers to patient bed 1100.

The frame central segment 1320 may include one more armrest 1326 positioned on each side of the segment. The armrests 1326 can support patient arms and also serve as side rails to prevent patients from shifting off of the patient when in use. In addition, as shown in FIG. 11, the armrest rails 1326 can secure panels of headboard 2100 to the bundled patient bed 1100 for storage and transport.

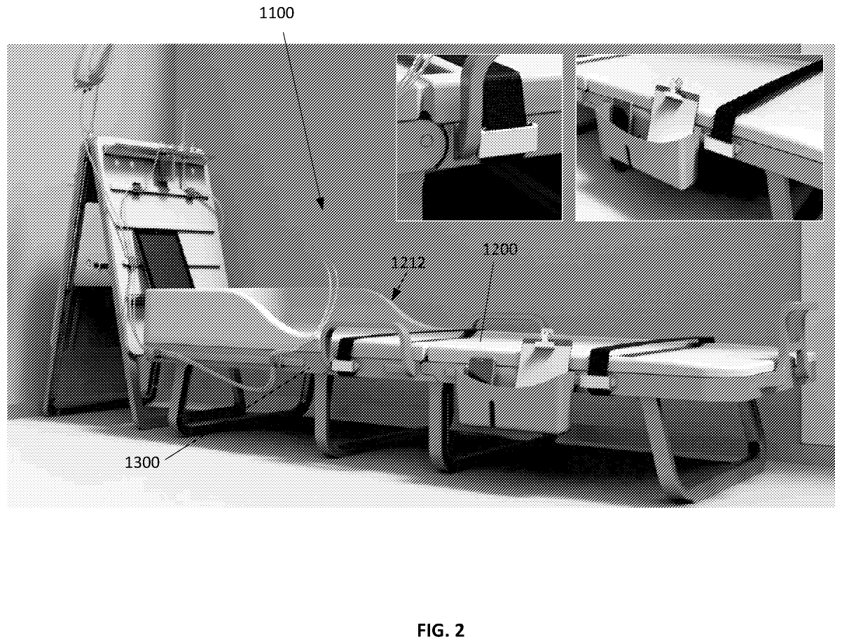

The frame central segment 1320 can include a plurality of brackets 1306, as described elsewhere herein, that are positioned along the outer surface of the sides. Each side may include up to about 1 bracket, about 1 to 2 brackets, or more than 2 brackets. In some embodiments, patient bed 1100 is positioned in an active configuration for patient use, and brackets 1306 are used to attaching accessories that aid in implementation of patient care, shown in FIG. 2. For example, brackets 1306 may be used for attaching belts to patient bed 1100 for securing or stabilizing patients to the patient bed when in use. In some embodiments, patient bed 1100 is positioned in an inactive configuration for storage or transportation, and brackets 1306 are used for securing components of patient bed 1100 and headboard 2100 assembly in the bundled configuration, shown in FIG. 13.

Referring now to FIGS. 8 and 9, frame 1300 can include foot segment 1330. Foot segment 1330 can includes a plurality of crossbars 1301 extending the width of the frame along foot segment 1330. In some embodiments, the crossbars 1301 mirror the crossbar configuration of frame head segment 1310. Foot segment includes a handle 1331 positioned orthogonal to the plane of patient bed 1100, and centered on the bottom edge of the foot segment 1330 of frame 1300. The handle 1331 on foot segment 1330 is positioned to mirror the handle 1311 positioned on head segment 1310. Foot segment 1330 includes a plurality of brackets 1306 positioned along the side edges of the frame, shown in FIG. 8, and as described elsewhere herein. As shown in FIGS. 1, 2, 3, 4 and 5, brackets 1306 along the side of foot segment 1330 can be used to attach accessories for facilitating patient care. For example, as shown in FIGS. 1-5, one or more trays may be attached to the bracket on frame foot segment. In other embodiments, as shown in FIGS. 1, 2 and 5, one or more belts for securing patients to patient bed 1100 may be attached to or through one or more brackets 1306 on foot segment 1330.

Foot segment 1330 can be elevated above the ground by a folding support 1308. As shown in FIGS. 8 and 9, support 1308 can hinge from foot segment 1330 in an active configuration similar to the support 1308 under head segment, described herein. As shown in

FIG. 20, support 1308 under foot segment can fold flat against the bottom of frame 1300 in a resting position for storage and transport.

Frame 1300 can include hinge regions 1325 that connect the frame's head segment 1310 and foot segment 1330 to the frame's central segment 1320. The hinge regions 1325 may include a continuous flexible seam or may include one or more discrete hinges connecting head segment 1310 and foot segment 1330 to central segment 1320. The hinges may include ratcheting hinges, smooth hinges, fixed-radius hinges, or unrestricted hinges. In some embodiments, the hinges form a maximum angle of 180° between either central segment 1320 and head segment 1310 or central segment 1310 and foot segment 1330 when in a completely open configuration allowing a patient to assume a supine position. In some embodiments, the hinges form a minimum angle of 90° between either central segment 1320 and head segment 1310 or central segment 1320 and foot segment 1330 when in a completely closed configuration for storing or transporting the patient bed. The angle between head segment and central segment and the angle between foot segment and central segment may be the same angle. The angle between head segment and central segment and the angle between foot segment and central segment may be different angles. The one or more angles may include an angle measuring from about 0° to about 15°, from about 15° to about 30°, from about 30° to about 45°, from about 45° to about 60°, from about 60° to about 75°, from about 75° to about 90°, from about 90° to about 105°, from about 105° to about 120°,from about 120° to about 135°, from about 135° to about 150°, from about 150° to about 165°, from about 165° to about 180°, and any and all increments and intervals therebetween. Any and all segments of frame 1300 may be constructed from any suitable materials as understood in the art. Frame 1300 may be constructed from one or more non-oxidizing or noncorrosive materials such as, for example, one or more metals, plastics and or combinations thereof. Frame may be constructed from aluminum and/or one or more alloys thereof, molded plastic, fiberglass, and/or combinations thereof.

Headboard Component

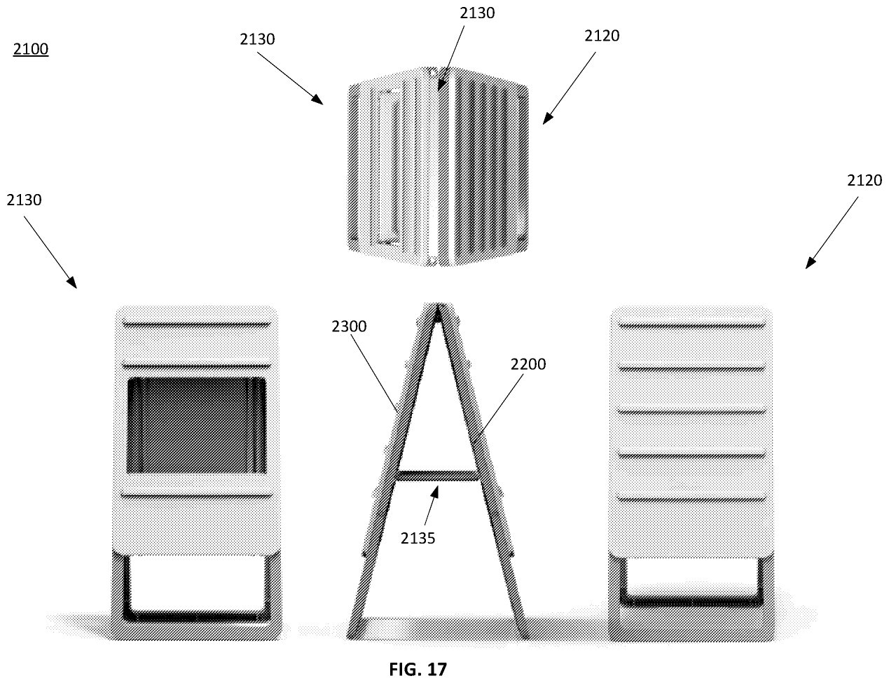

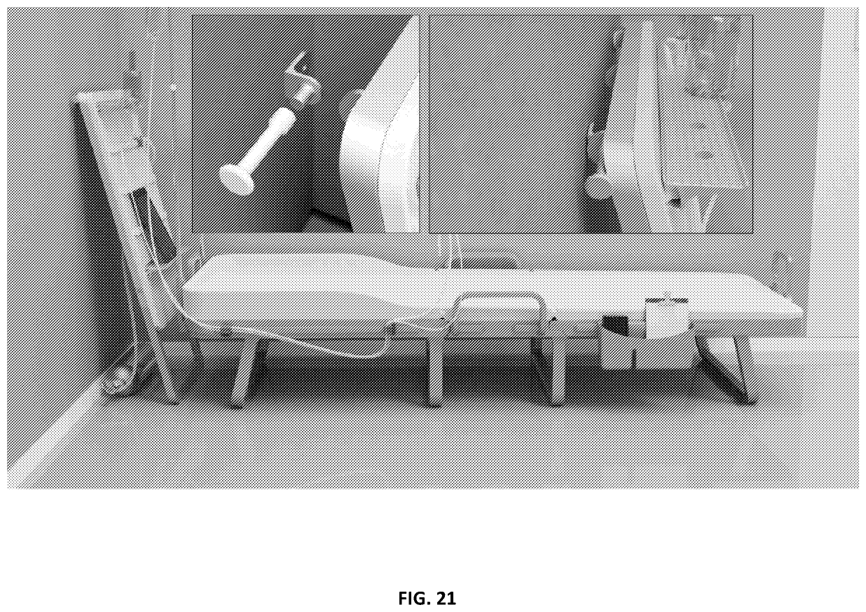

Referring now to FIG. 1, patient bed-and-headboard system include a headboard 2100 that includes a tubular frame 2200 and one or more panels 2300. In some embodiments, the headboard 2100 stands independently in an easel-like, A-frame configuration, such as that shown in FIG. 17. In some embodiments, the headboard 2100 may include only a front panel and may be mounted to, for example, a wall adjacent to the patient bed component 1100, shown in FIG. 21.

Referring now to FIG. 17, embodiments of headboard 2100 are self-standing. The self-standing headboard 2100 includes a frame 2200 and panels 2300. The assembled frame and panels have a front headboard component 2110 and a rear headboard component 2120 connected along a top edge 2130 by one or more hinges 2130. As shown in FIG. 17, a center panel 2135 in the rear headboard component 2130 can fold down and latches with the front headboard component 2120 to secure the headboard 2100 in an assembled A-frame configuration. In addition, the surface of the folded center panel 2135 can be used as a shelf. For example, as shown in FIGS. 1, 3 and 4, the shelf formed by center panel 2135 can be used to store, for example, gas canisters for ease in administration of gases such as oxygen to patients in need thereof.

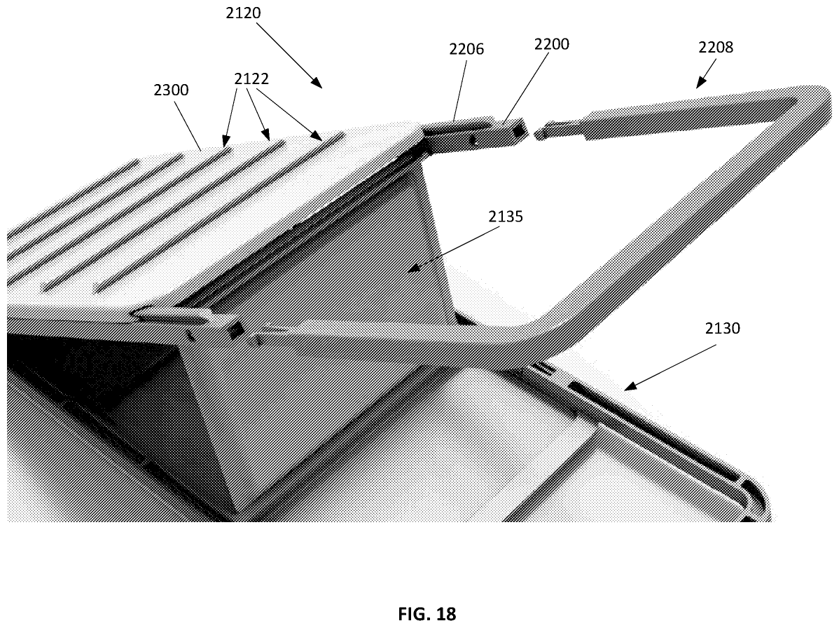

Referring now to FIG. 18, the vertical faces of the front and rear components of frame 2200 include one or more attachment points 2206 for securing one or more panels 2300 to the face of the frame. Embodiments of the attachment points 2206 include keyed attachment points, brackets, ridges, rails, and the like. The one or more panels 2300 include complementary keyed grooves for engaging with the frame at the one or more attachment points 2206, as shown assembled in FIG. 18.

Referring now to FIG. 17, front panel 2120 can mount onto the front of the frame and includes a plurality of horizontal ledges 2122 extending the width of the panel. As shown in FIG. 1, the ledges 2122 may be used to attaching accessories to the headboard 2100 for facilitating in the implementation of patient care. For example, one or more trays, brackets and the like may be attached to the front panel for securing mobile patient monitoring devices, fluid lines (e.g. i.v. fluid lines, gas lines, etc.), and the like.

Referring now to FIG. 18, the frame 2200 of headboard 2100 may include one or more removable base supports 2208. The base supports 2208 can be removed for storage and transporting of the headboard. The base supports 2208 can be attached to the headboard frame 2200 for adding height to the headboard assembly 2100.

Referring now to FIG. 21, embodiments of headboard 2100 include a single frame and panel component. For example, embodiments of the headboard only include a front component 2120 having a frame 2200 and panel 2300. The single panel headboard may be leaned against or vertical surface, for example a wall or other stable structure. Embodiment of the single headboard may include one or more brackets for mounting the single panel to the wall, for example, to lock the headboard into a fixed position for stability during use, shown in FIG. 21.

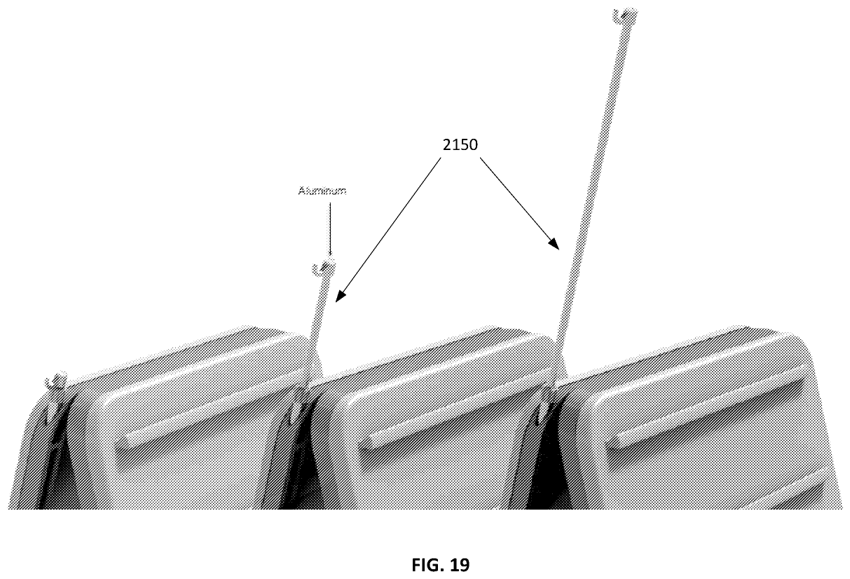

Referring now to FIG. 19, the frame 2200 of headboard 2100 may include one or more adjustable, collapsible stands 2150 for hanging medical supplies above a patient at a preferred height. For example, as shown in FIG. 19, the collapsible stand 2150 can be positioned in a first, collapsed position for securing a supply at the height of the headboard, and/or when the stand is not in use. The stand 2150 can telescope to a second, extended position and secured at a preferred height for hanging, for example, an i.v. bag for delivering fluids to a patient, a lamp or light source, and the like. The telescoping collapsible stand 2150 can be positioned, for example, at a preferred height for facilitating gravity-driven flow of one or more fluids to one or more patient fluid lines.

Referring now to FIG. 21, embodiments of telescoping stand 2150 may attach to the head segment of patient bed 1100. For example, embodiments of patient bed-and-headboard assembly that include a single panel headboard may include a telescoping stand that attaches to patient bed.

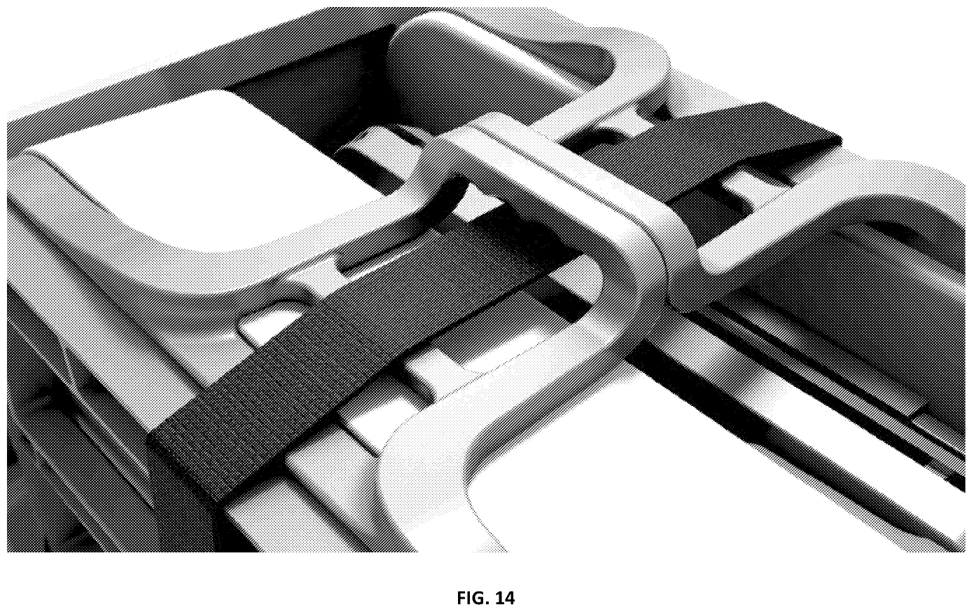

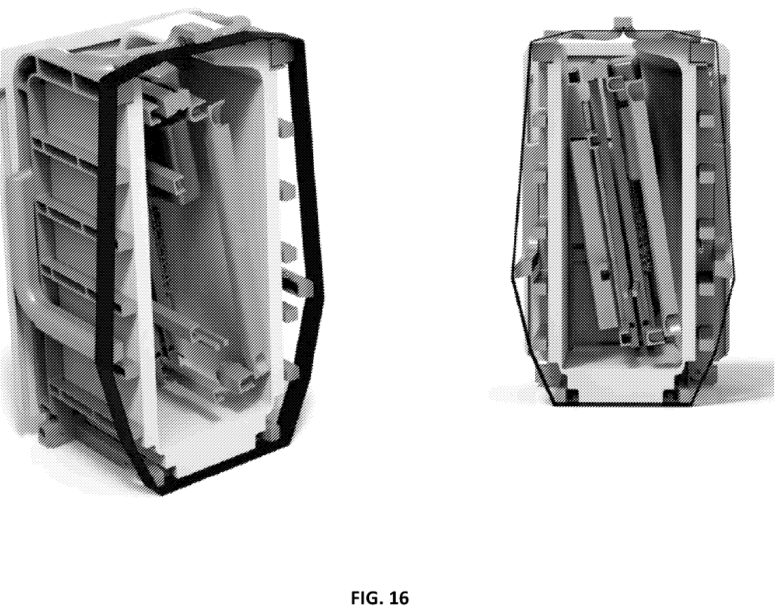

Referring now to FIG. 15, patient bed-and-headboard assembly 100 is fully collapsible and self-contained when not in use. As described herein, both the head and foot segments of pad 1200 and frame 1300 of patient bed 1100 fold from a horizontal position for patient use to a vertical position for storage and containment. The legs or supports of both the patient bed frame 1308 and headboard frame 2208 are removable or collapsible. As shown in FIG. 16, the frame components 2200 of headboard 2100 are contained inside the collapsed patient bed 100. As shown in FIGS. 10, 11, the headboard panels 2300 engage with sides of central segment of the patient bed 1100. As shown in FIG. 13, the brackets 1306 along the face of patient bed frame 1300 engage with the slots or grooves in headboard panels 2300, which slide behind and are secured by armrest rails 1326. As shown in FIGS. 11, 14 and 16, one or more belts secure the collapsed bed-and-headboard assembly in a collapsed configuration for storage and transporting. The one or more belts may include the one or more belts shown, for example, in FIGS. 1, 2, and 5 for securing a patient to patient bed 1100.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A self-contained patient-bed-and-headboard assembly comprising:
a patient bed comprising:
a central region;
a head region hingedly attached to the central region; and
a foot region hingedly attached to the foot region;
wherein both the head region and the foot region:
can rotate between:
a first position in which the head region and the foot region are substantially upright; and
a second position in which the head region and the foot region are coplanar; and
each comprise one or more lateral attachment points; and
a headboard comprising one or more complementary attachments points adapted and configured to engage with the one or more lateral attachment points of the head region and the foot region of the patient bed when in the first position.

2. The self-contained patient-bed-and-headboard assembly of claim 1, wherein the lateral attachment points are rails.

3. The self-contained patient-bed-and-headboard assembly of claim 1, wherein the lateral attachment points have a keyed profile.

4. The self-contained patient-bed-and-headboard assembly of claim 3, wherein the complementary attachment points are grooves.

5. The self-contained patient-bed-and-headboard assembly of claim 1, wherein the headboard comprises:
a front portion; and
a rear portion adapted and configured to couple to the front portion to form an A-frame.

6. The self-contained patient-bed-and-headboard assembly of claim 5, wherein each of the front portion and the rear portion comprises the one or more complementary attachment points.

7. The self-contained patient-bed-and-headboard assembly of claim 6, wherein the front portion of the headboard and the rear portion of the headboard are each adapted and configured to couple to a separate lateral side of the patient bed.
